(19) United States
(12) Patent Application Publication
(10) Pub. No.: US 2004/0061038 A1
(43) Pub. Date: Apr. 1, 2004

(54) Work pattern support

(76) Inventor: Catherine Solich, Cape Coral, FL (US)

Correspondence Address: Catherine Solich, 829 SW 15TH Ave., Cape Coral, FL, 33991, US

(21) Appl. No.: 10/255,191

(22) Filed: Sep. 27, 2002

(51) Int. Cl. F16B 1/00

(52) U.S. Cl. 248/444; 248/229.1

(57) ABSTRACT

The invention is directed to a support for a pattern in front of a person in the process of doing embroidery work. This process involves a two-handed process will doing embroidery or other work while at the same time displaying the pattern from which the work at hand progresses. To this end, there is a support to display the pattern in substantially the eye sight of the person doing the embroidery. The support may clamped to an arm chair of an upholstered piece of furniture at home or the upper thigh of a leg when the upholstered piece of furniture is not available such as in the waiting room of a physician or others. The support device can be clamped to a substantially circular structure and carries a display device for a pattern of the work in progress. The support device has either a flexible support rod or one that is rigid. In either case the hands of the person performing the task of embroidery or other work are free to move at will.

### CROSS REFERENCE TO RELATED APPLICATIONS

(none)

### STATEMENT REGARDING FED SPONSORED R & D

(none)

### BACKGROUND OF THE INVENTION

The invention at hand is directed to a support that supports a work pattern. More specifically, the work support is a pattern that is used as an instruction on a line by line basis as how to proceed on a line by line basis when undergoing the task of embroidery. It is important that every line and every point of stitching be faithfully followed according to what the pattern indicates. Applicant's prior Pat. No. is a magnifying glass that shows the viewer exactly how to proceed stitch-by-stitch according to a predetermined pattern. This pattern with the magnifying glass attached thereto is not always convenient to handle during the act of embroidery because it takes two hands to do the embroidery itself but the pattern is located somewhere else. The invention at hand solves this problem by presenting the pattern including the magnifying glass Win a convenient position in front of the eyes of the person doing the embroidery without having to readjust the position of the viewing area of the pattern under a magnifying glass as the act of embroidering progresses

It is well known in the art that various objects are being supported from various supports. That is, it is known to support a magnifying glass from a standard that is supported from a floor. The same magnifying glass is known to be supported by way of a clamp from a table or other object. It is also well known to support a light (reading or otherwise) from a floor or from a table. It also known to support a light having a flexible rod from an adapter in a cigarette lighter in a car that can be moved into different directions for the convenience of a passenger, while reading, for example, that will not visually interfere with the driver of a car.

### BRIEF SUMMARY OF THE INVENTION

The invention at hand has an object to present a pattern including a magnifying glass to a person to do work in a convenient location. Just placing a pattern in front of a person to do embroidery work on a table is not conducive to the flow of the work. It would much more practicable to place the pattern including the magnifying glass in the most convenient position and that is, in front of the eyes of the person working n a project. The invention at hand will accomplish this as will be explained below.

### BRIEF DESCRIPTION OF THE DRAWINGS

FIG. 1 illustrates a person sitting in an upholstered chair where the support device is clamped to an arm rest;

FIG. 2 illustrates the person of Fig. without a chair wherein the work support is attached to her own leg;

FIG. 3 shows the support itself including a flexible rod;

FIG. 4 shows the support itself including a rigid rod;

FIGS. 5A through 5C illustrate various ways of fastening a work pattern to a support at the upper end of the support;

FIG. 6 shows a clamp that can be used on different support surfaces.

### DETAILED DESCRIPTION OF THE INVENTION

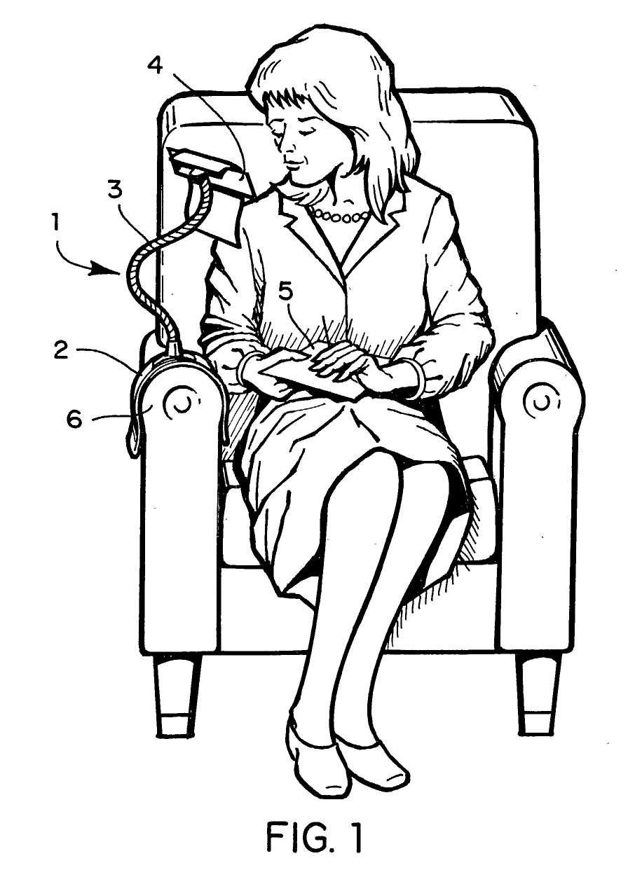

FIG. 1 shows a person sitting in an upholstered chair having an arm rest 6. The person that is doing the work, such as embroidery, that requires both hands to accomplish the task. It is important that the work pattern 4 be in a convenient position so as to observe the progress in the pattern as the work progresses. For this purpose, the work support as depicted by 1 is used.

The work support 1 includes a clamp 2 that is clamped around the arm rest 6 of the chair the person is sitting in. The clamp has a flexible rod attached thereto that can be bent in many different ways to accommodate the vision of the person doing the work 5. At the top of the flexible rod 3 a clamp or any other implement is provided that holds the work pattern 4 in place. At the time, the flexible rod 3 could support a magnifying glass or a light to illuminate the work 5 in progress.

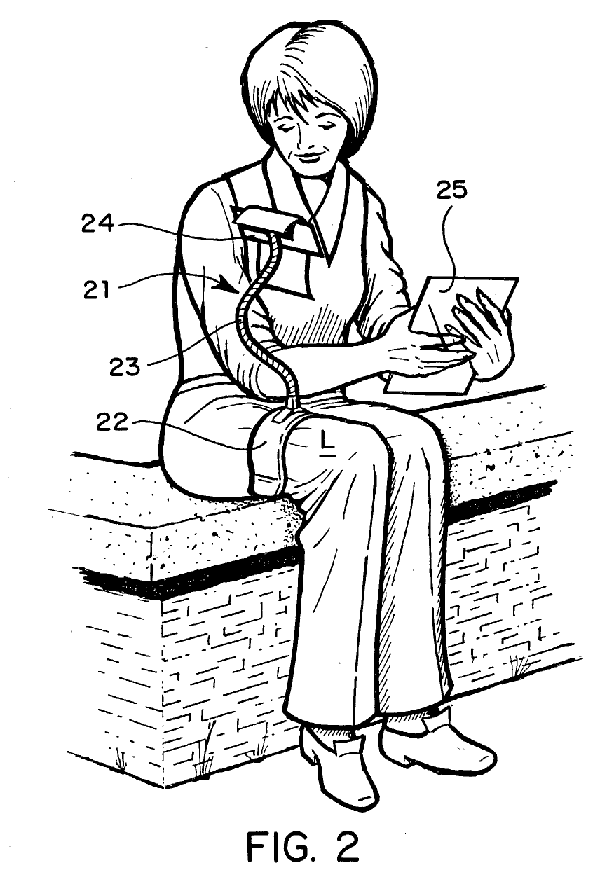

FIG. 2 illustrates the same circumstance as in FIG. 1 instead the clamp 22 is clamped to the leg L of the artist. For this purpose, the clamp 22 is provided that has a flexible rod 23 attached thereto as an overall support 21. At the top of the flexible rod 23 there is attached an upper clamp 24 to receive the pattern in progress. The person again is working of some kind of needle work requiring the use of both hands.

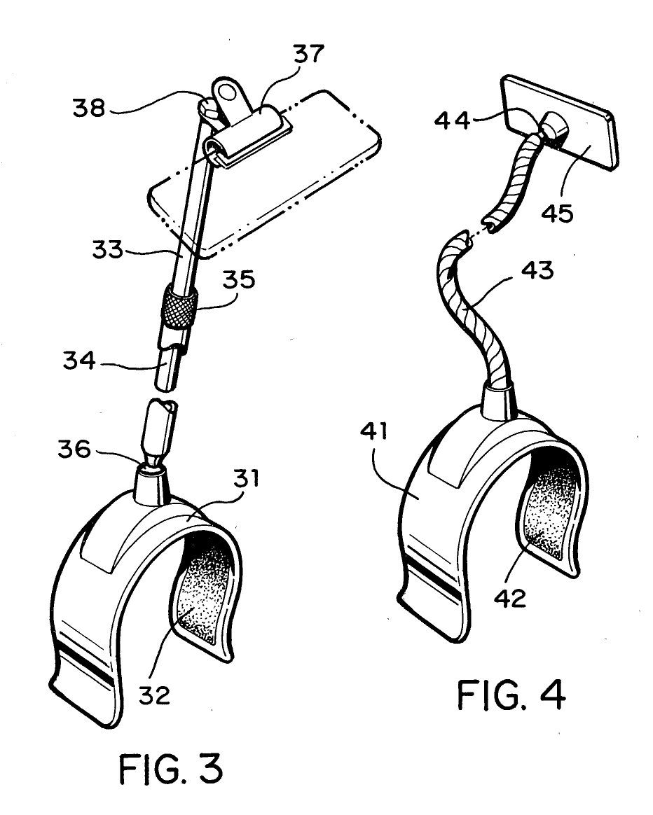

FIG. 3 illustrates the details of the supporting device that was explained in FIGS. 1 and 2. The clamp 31 that can be clamped to the arm rest 6 of FIG. 1 or the upper leg L of FIG. 2 is shown in more detail. The width of the clamp 31 should be wide enough to stabilize the support on either the arm chair or the leg. The clamp 31 should also have a friction material 32 applied to the inner surface of the clamp to further aid in stabilizing the clamp 31 once it is applied to the arm chair 6 or the leg L The support system in FIG. 3 shows a rigid rod 33 attached to the clamp 31 by way of a friction ball joint which allows the rod 33 to be moved in a multiple of directions. It is also desirable that the rod 33 can be moved into different lengths. This is accomplished through the use of a telescoping extension rod 34 using a clamping knob to adjust the height at a desired extension. A clamp 37 may be attached at the top of the rod 33 by way of the bolt or other attachment 38. The clamp 37 may receive the pattern of work in progress.

FIG. 4 is a similar construction of FIG. 3 except that the rigid rod 33 is replaced by a flexible rod 43. At the top of the flexible rod 43 a plate 45 is attached by way of the friction ball joint 44.

The attachment plate can receive many different accessories in may different ways as will be explained below.

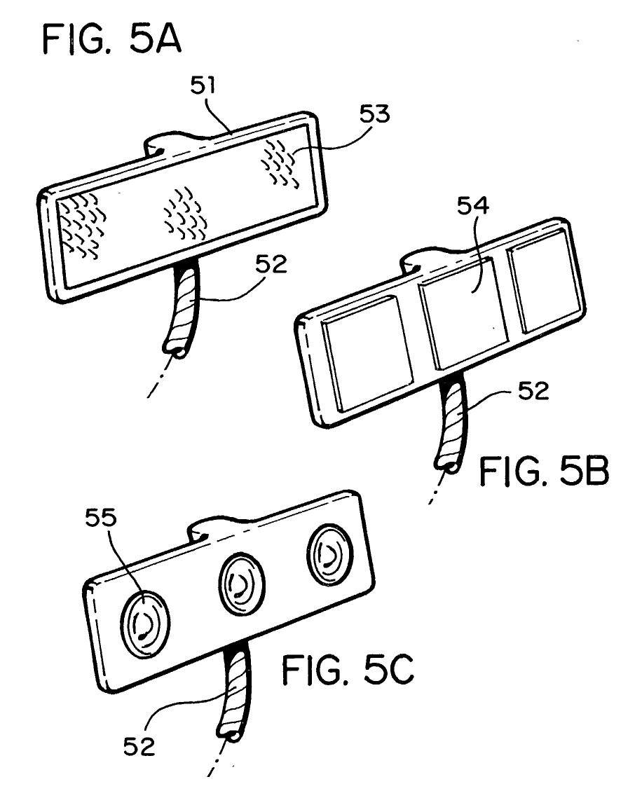

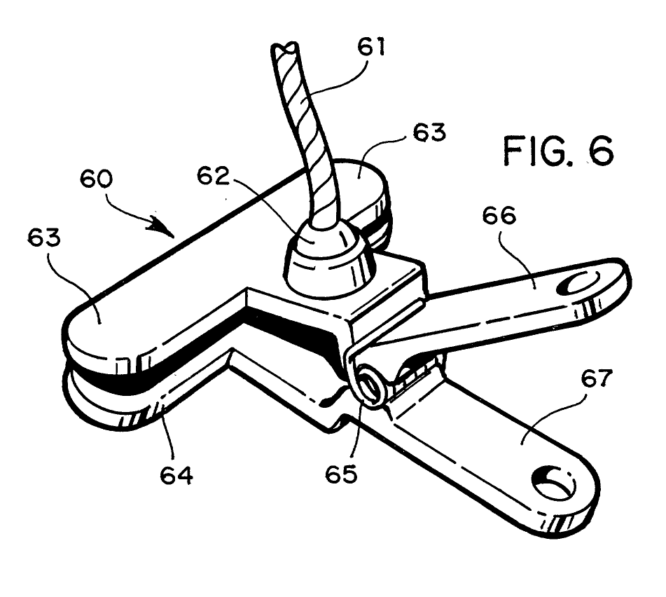

FIG. 5A shows the plate 45 of FIG. 4 as 51 in this Fig. The front of the plate 51 can have attached thereto one part of the well known hook and loop fastening system, while any pattern system to be attached thereto will carry the other part to be attached to the first part.

FIG. 5B shows the same system as is shown in FIG. 5A except that magnets 54 are used to attached anything to the plate 51.

in FIG. 5C the hook and loop fasteners of A and the magnets of B are replaced by the snaps 55 as an alternative to various fastening systems.

What is claimed is:

1. A support device for a hands free pattern display for a work in progress comprising a clamp of a substantial circular construction adapted to be clamped to a substantial circular object, said support device including a rod movable into different directions, said rod having at an upper end thereof a means for fastening a pattern of a work progress thereon with a lower end of said rod being fastened to said clamp.

2. The support device of claim 1, wherein said rod is rigid and a lower end of said rod is fastened to said clamp by way of a bull joint compression fitting.

3. The support device of claim 2, wherein said rigid rod has a telescoping joint therein to lengthen or shorten said rod.

4. The support device of claim 2 including a ball joint connection fastened between the said upper end of said rod and the means for fastening a pattern of work in progress.

5. The support device of claim 1, wherein said rod is flexible to be able to be moved into different directions.

6. The support device of claim 6, wherein an inside surface of said clamp of substantial circular construction has friction material placed thereon.

7. The support device of claim 6 wherein said friction material is the hook material of the hook and loop fastening system.

8. The support device of claim 1, wherein said means for fastening a work in progress pattern includes a plate having hooks thereon of the hook and loop fastening system.

9. The support device of claim 1, wherein said means for fastening a work in progress pattern includes a plate having magnets thereon.

10. The support device of claim 1, wherein said means for fastening a work in progress pattern includes a plate having snaps thereon.

11. The support device of claim 1, Wherein said substantially circular clamp is a flat base clamp.

12. The support device of claim 11 including joint to support said rod is a ball joint to allow said rod to move in many different locations.

13. A support device for a hands free pattern display for a work in progress comprising a clamp adapted to be clamped to an object, said support device including a rod movable into different directions, said rod having at an upper end thereof a means for fastening a pattern of a work in progress thereon with a lower end of said rod being fastened to said clamp.

14. The support devoce of claim 13, wherein said means for fastening a pattern of work in progress thereon is a plate having friction means thereon for fastening said work in progress thereon.
